(19) United States
(12) Patent Application Publication
(10) Pub. No.: US 2019/0118695 A1
(43) Pub. Date: Apr. 25, 2019

(54) ENCLOSED TRANSPORT TRAILER FOR HAULING AN ELONGATED BODY

(71) Applicant: Lauren R. Isaac, Dewberry (CA)

(72) Inventor: Lauren R. Isaac, Dewberry (CA)

(21) Appl. No.: 16/020,215

(22) Filed: Jun. 27, 2018

Related U.S. Application Data
(60) Provisional application No. 62/574,856, filed on Oct. 20, 2017.

(51) Int. Cl. B60P 3/22; B60P 3/40; B62D 63/06; B62D 63/08; B60P 1/52; B60G 17/04

(52) U.S. Cl. CPC B60P 3/2215; B60P 3/40; B62D 63/062; B62D 63/08; B60P 1/52; B60G 2800/0192; B60G 2202/152; B60G 2300/04; B60G 2500/20; B60G 2500/30; B60G 17/04

(57) ABSTRACT

A transport trailer for transporting an elongated body features a containment structure supported on a trailer frame so as to define a hollow interior suitable to receive the elongated body therein. The containment structure includes a receptacle portion defining a receptacle for containing a noxious substance carried on the body, an access opening at a top side of the receptacle portion for accessing the interior of the containment structure, and a closable lid carried on the receptacle portion. The lid is movable relative to the access opening between an open position in which the access opening is unobstructed and a closed position in which the access opening is covered so as to close the containment structure. There also are provided load bearing surfaces within the containment structure which are supported on the frame and anchoring locations on an inside of the containment structure for receiving straps to secure the body.

This application claims the benefit under 35 U.S.C. 119(e) of U.S. provisional application Ser. No. 62/574,856, filed Oct. 20, 2017.

### FIELD OF THE INVENTION

The present invention relates generally to a transport trailer, and more particularly to such a trailer having a containment structure which can be receive a body therein.

### BACKGROUND

In some instances, equipment carrying a noxious substance thereon needs to be transported from one location to another. An oilfield heat exchanger in the form of a package of tubes supported in a tank which contains a fluid with which the tube package exchanges heat may form one such example of equipment carrying noxious substance. Typically, flat deck transport trailers are used for carrying this equipment, but there is no suitable means on such trailers for containing the noxious substance dripping therefrom, which may present an environmental hazard.

### SUMMARY OF THE INVENTION

According to an aspect of the invention there is provided a transport trailer for transporting an elongated body carrying a noxious substance thereon, the transport trailer comprising:

a frame having a forward end and a rear end;

a hitch coupling supported at the forward end of the frame for connecting to a tow vehicle;

a plurality of wheel and axle assemblies rotatably supported at the rear end of the frame;

a containment structure supported on the frame so as to define a hollow interior suitable to receive the elongated body therein, the containment structure including a receptacle portion defining a receptacle for containing the noxious substance, an access opening at a top side of the receptacle portion for accessing the interior of the containment structure, and a closable lid carried on the receptacle portion and movable relative to the access opening between an open position in which the access opening is unobstructed and a closed position in which the access opening is covered so as to close the containment structure;

the interior of the containment structure being unobstructed from a front to a rear thereof in a manner so as not to obstruct placement of the elongated body therein;

load bearing surfaces within the containment structure which are supported on the frame;

and anchoring locations on an inside of the containment structure for receiving straps to secure the elongated body inside the containment structure in fixed relation against the load bearing surfaces within the containment structure.

According to another aspect of the present invention there is provided a containment structure for transporting an elongated body carrying a noxious substance using a transport trailer in which the transport trailer includes a trailer structure having a forward end and a rear end, a hitch coupling supported at the forward end of the trailer structure for connecting to a tow vehicle, a plurality of wheel and axle assemblies rotatably supported at the rear end of the trailer structure, the containment structure comprising:

a frame for being received on the trailer structure of the transport trailer;

a containment structure supported on the frame so as to define a hollow interior suitable to receive the elongated body therein, the containment structure including a receptacle portion defining a receptacle for containing the noxious substance, an access opening at a top side of the receptacle portion for accessing the interior of the containment structure, and a closable lid carried on the receptacle portion and movable relative to the access opening between an open position in which the access opening is unobstructed and a closed position in which the access opening is covered so as to close the containment structure;

the interior of the containment structure being unobstructed from a front to a rear thereof in a manner so as not to obstruct placement of the elongated body therein;

load bearing surfaces within the containment structure which are supported on the frame;

and anchoring locations on an inside of the containment structure for receiving straps to secure the elongated body inside the containment structure in fixed relation against the load bearing surfaces within the containment structure.

In one arrangement there are provided a plurality of load supporting members at longitudinally spaced locations inside the containment structure supported on the load bearing surfaces for carrying the elongated body thereon, and at least one of the load supporting members is displaceable along a track inside the containment structure extending in a longitudinal direction of the frame for adjusting a position of said at least one of the load supporting members longitudinally of the containment structure.

In one arrangement the at least one of the load supporting members comprises rollers rotatably supported on either side thereof that rollably engage a respective track on either side of a central longitudinal axis of the containment structure.

Typically the frame comprises a pair of longitudinally extending beams and preferably in such an arrangement the respective track is formed on each one of the pair of longitudinally extending beams.

Preferably the longitudinally extending beams of the frame protrude partway into the containment structure such that the load supporting members each are carried at a spaced position above a bottom of the containment structure.

In one arrangement each load supporting member includes an upper supporting surface having a central location which is lower than opposite sides of the respective load supporting member so as to form a cradle.

In one arrangement a bottom interior surface of the containment structure is sloped downwardly from either side of the containment structure so as to define a trough extending longitudinally of the frame.

Preferably there is provided a drain in a bottom of the containment structure that is communicated with the interior of the containment structure so that the noxious substance collected by the receptacle portion of the containment structure can be removed.

Preferably the drain is located closer to the front of the containment structure than to the rear thereof and the wheel and axle assemblies comprise gas bags operable for lifting the rear of the frame so as to dispose the containment structure in an inclined position so that the noxious substance flows by gravity towards the front of the containment structure for removal via the drain.

Typically in such an arrangement the drain is located at the front of the containment structure.

In one arrangement the frame comprises: a center frame having forward and rear ends;
a forward frame at the forward end of the center frame supporting the hitch coupling;

a rear frame at the rear end of the center frame supporting the wheel and axle assemblies;

each of the center frame, the forward frame, and the rear frame including at least one longitudinally extending beam;

wherein the containment structure is on the center frame and a lower boundary of the containment structure is below the at least one beam of the rear frame and of the forward frame.

The transport trailer may include an operator support member located externally of the containment structure and defining a substantially horizontal upper surface projecting transversely from an upstanding wall of the containment structure, the upper surface extending longitudinally of the frame for supporting an operator along a length of the containment structure.

In one arrangement the receptacle portion includes a bottom and a peripheral wall extending upwardly from bottom to an upper perimeter edge which delimits the access opening, the lid is pivoted about a pivot axis along one side of the peripheral wall and a portion of the upper perimeter edge opposite the pivot axis is located at a lower height than a portion of the upper perimeter edge along which the pivot axis extends.

Typically the transport trailer further includes at least one actuator for actuating the pivotal movement of the lid between open and closed positions.

Preferably the access opening spans a full length of the containment structure.

Preferably the transport trailer includes a first locking member carried on a peripheral wall of the containment structure that is cooperative with a second locking member carried on the lid to secure the lid in the closed position.

For example, the elongated body is a heat exchanger in the form of a package of tubes used in oil and gas industry.

### BRIEF DESCRIPTION OF THE DRAWINGS

The invention will now be described in conjunction with the accompanying drawings in which:

FIG. 1 is a side elevational view of one arrangement of a transport trailer according to the present invention in which a lid of the transport trailer is shown in a closed position.

FIG. 2 is a perspective view of the container of the transport trailer of FIG. 1 shown separated from the trailer with the container in an open position.

FIG. 3 is a cross-sectional view along line 3-3 in FIG. 1 showing two examples of elongated body of different size which can be received in a containment structure of the transport trailer.

FIG. 4 is a perspective view of one of the load supporting members inside the container of the trailer of FIG. 1.

FIG. 5 is a close-up perspective view of locking members of the arrangement of FIG. 1.

FIG. 6 is a schematic end view of oilfield equipment being lowered into the container of the trailer according to FIG. 1 using a crane.

FIG. 7 is a longitudinal sectional view of a rear of the arrangement of FIG. 1 showing wheel and axle assemblies in greater detail.

FIG. 8 is an schematic end view of an alternative embodiment of the container for ready separation from the structural trailer frame.

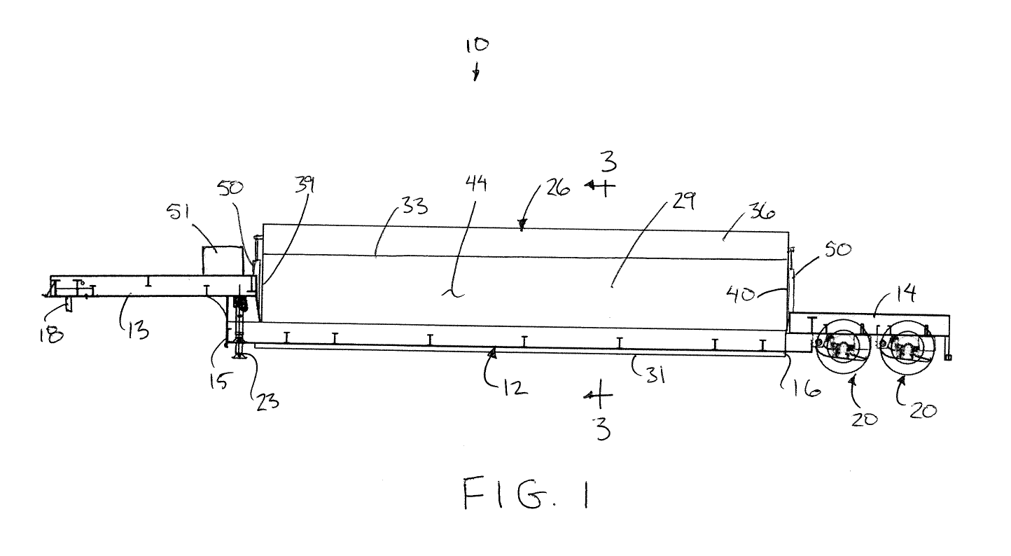

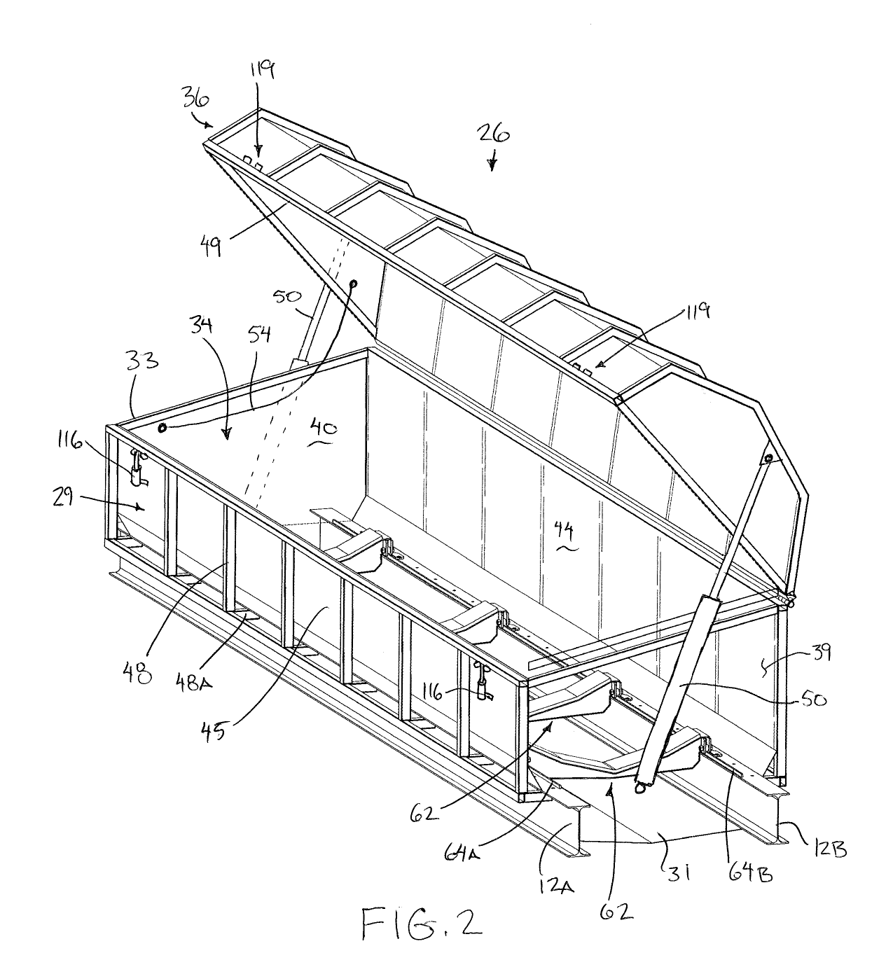

In the drawings like characters of reference indicate corresponding parts in the different figures.

### DETAILED DESCRIPTION

The accompanying figures show a transport trailer 10 suited for transporting an elongated body 1 (schematically shown) carrying a noxious substance thereon. One such example of elongated body is a heat exchanger in the form of a package of tubes 3 used in oil and gas industry. This heat exchanger is supported in a tank which contains a fluid with which the tube package exchanges heat, and thus upon removal from the tank for example for servicing/maintenance at least a residue of the fluid remains on the package of tubes. This leaky residue may present an environmental hazard. Thus is provided the transport trailer 10 which can enclose the elongated body to contain the noxious substance.

The transport trailer 10 comprises an overall frame which, in the illustrated arrangement, includes three frame sections 12 through 14. There is provided a center frame 12 having a forward end 15 and a rear end 16; a forward frame 13 which is connected at the forward end 15 of the center frame and which supports a hitch coupling; and a rear frame 14. Thus, generally speaking, the forward frame 13 is located at a forward end of the overall frame. The hitch coupling typically is in the form of a king pin 18 (schematically shown) depending downwardly from the forward frame 13 so as to be exposed beneath the forward frame and available for coupling to a tow vehicle (not shown). The rear frame 14 is connected at the rear end 16 of the center frame that rotatably supports a plurality of wheel and axle assemblies 20.

Each of the frame sections 12 through 14 of the illustrated arrangement comprises a pair of longitudinally extending I-beams which are indicated at 12A-B for the center frame, 13A-B for the forward frame, and 14A-B for the rear frame. The beams 12A-B of the center frame are lowered relative to both the beams of the forward frame and the rear frame such that during transport the center frame is carried closer to the ground and thus has a lower center of gravity in comparison to the forward and rear frames.

At the forward end 15 of the center frame are provided conventional jacking legs 23 which can be raised for transport and can be lowered when the trailer 10 is parked and is disconnected from the tow vehicle, such that a bottom of the trailer at the center frame is spaced from the ground when parked.

In order to contain the elongated body and the noxious substance, the transport trailer includes a containment structure generally indicated at 26 which specifically, in the illustrated arrangement, is supported on the center frame 12.

The containment structure 26 includes a receptacle portion 29 comprising a bottom pan 31 formed by a sheet spanning between the center frame beams 12A-B and defining a bottom of the containment structure. As the longitudinal beams 12A-B of the center frame are located at a lower height than those of the forward frame and the rear frame, and since the pan meets each beam at a bottom thereof, a lower boundary of the containment structure that is defined in the illustrated arrangement by the pan 31 is located below the longitudinal beams of the rear frame and those of the forward frame. The receptacle portion additionally includes a peripheral wall extending upwardly from the pan 31 to an upper perimeter edge 33 delimiting an access opening 34 at a topside of the receptacle portion. The access opening 34 provides for access to a hollow interior of the containment structure which is defined substantially by the receptacle portion and closable at the top by lid 36.

In the illustrated arrangement the containment structure's peripheral wall is collectively formed by front and rear walls 39 and 40, which are distinct from forward and rear frame members 41, 42 connecting the center frame beams 12A-B to either the forward frame longitudinal beams or the rear frame longitudinal beams; by side walls 44 and 45 one of which is taller than the other so that its top is spaced above that of the lower wall 45; and by upright webs 47 of the center frame's beams 12A-B which span a height between the bottom pan 31 and bottoms of the side walls 44, 45. Tops of the front wall 39, rear wall 40, and side walls 44, 45 collectively define the upper perimeter edge 33. The tops of the front and rear walls 39, 40 are inclined downwardly from the taller one of the side walls 44 to the shorter side wall 45. Further, in the illustrated arrangement each of the side walls 44, 45 meets at its bottom an outer side of the respective beam 12A, 12B of the center frame, wherefrom the respective side walls extends upwardly and in an outward lateral direction at an incline to a side support post 48 providing structural rigidity at a side of the containment structure. A plurality of the support posts 48 are provided at longitudinally spaced locations externally of the containment structure at either side thereof, and are attached to the respective side wall 44 or 45. Each upright support post 48 is connected to the center frame by a short horizontal beam 48A elongated in a lateral direction of the frame and mounted to and extending laterally outwardly from the web 47 of the respective longitudinal beam 12A, 12B to a bottom of the respective support post. The respective side wall 44 or 45 from where it meets the respective support post 48 then extends substantially vertically upwardly to its top defining a portion of the upper perimeter edge 33.

The lid 36 has a domed transverse cross-section and is hinged at the taller one of the side walls 44 so that a pivot axis P of the lid is located along a higher one of the sides of the upper perimeter edge 33 and a portion of the upper perimeter edge opposite the pivot axis P, defined by the shorter side wall 45, is located at a lower height. The lid thus is carried on the receptacle portion of the containment structure and is movable relative to the access opening 34 in pivotal movement between an open position of the lid in which the access opening is unobstructed, and thus the elongated body can be placed in to the hollow interior of the containment structure, and a closed position of the lid in which the access opening is covered so as to enclose the hollow interior and close the containment structure. A lower rim 49 at a bottom side of the lid meets the upper perimeter edge 33 of the peripheral wall in the closed position of the lid. Further, the lid 36 spans the full length of the containment structure from front wall 39 to rear wall 40 as the access opening 34 spans the full length of the containment structure.

Actuators in the form of hydraulic cylinders 50 are provided for driving the pivotal movement of the lid 36 between the open and closed positions. The cylinders 50 which are driven by hydraulic pumps 51 supported on the overall frame of the transport trailer each are pivotally connected at one of the front and rear walls 39, 40 of the receptacle portion and at the lid 36 so that extension of the cylinders causes the lid to be pivoted upwardly about the pivot axis P to dispose the lid in the open position, and retraction of the cylinders causes the lid to be pivoted downwardly about axis P to dispose the lid in the closed position. The cylinders 50 are mounted so that in the closed position of the lid each cylinder is oriented substantially vertically upright.

A pair of braces 54 in the form of flexible links capable of withstanding tensile force, for example cables, are provided, each one operatively coupled between the lid 36 and one of the front wall 39 and the rear wall 40, acting to limit a range of upward pivotal movement of the lid about the pivot axis P and support the lid in the open position (so that the lid is not maintained in the open position solely by the cylinders 50, thereby reducing stress on same).

The hollow interior of the containment structure is unobstructed from a front to a rear thereof respectively defined by the front wall 39 and the rear wall 40 in that there are no members extending transversely across the interior in a manner which would otherwise obstruct placement of the elongated body in the containment structure. For example, there are no partitions compartmentalizing the containment structure into smaller distinct compartments. Thus, in effect the whole of the interior of the containment structure is available for containing the elongated body.

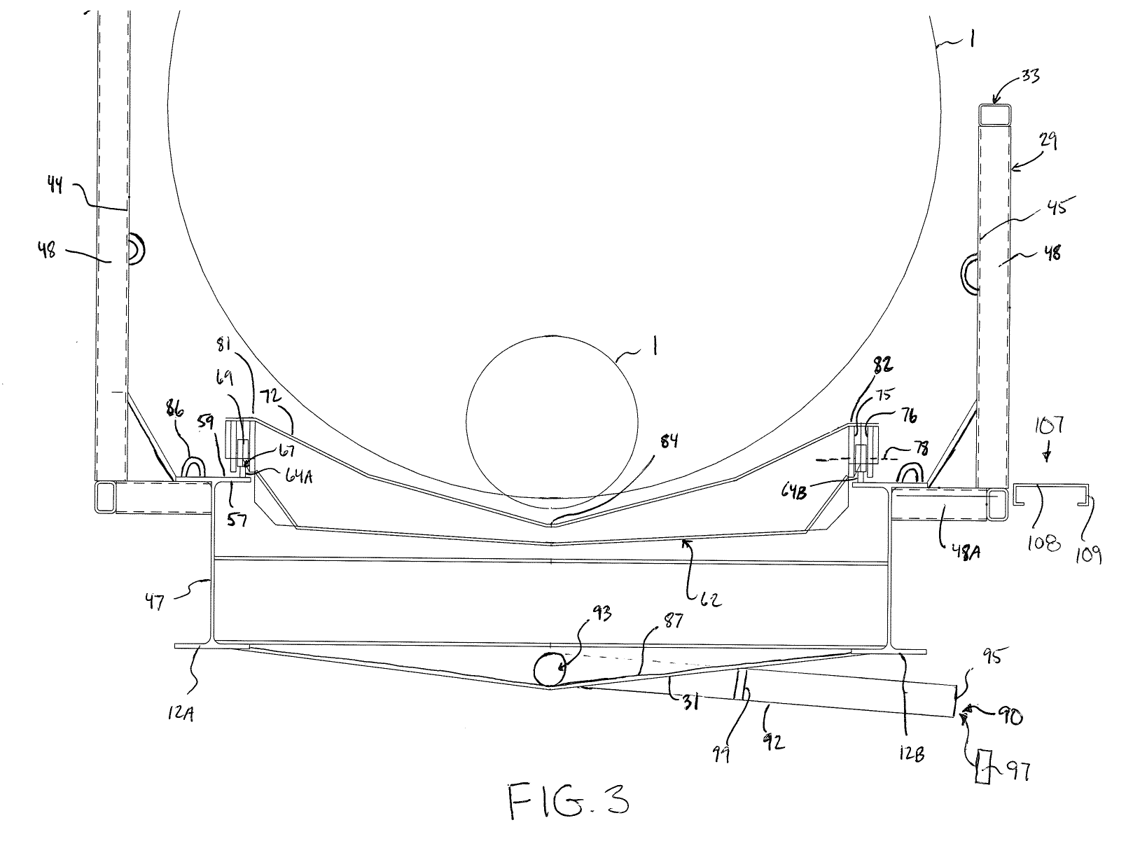

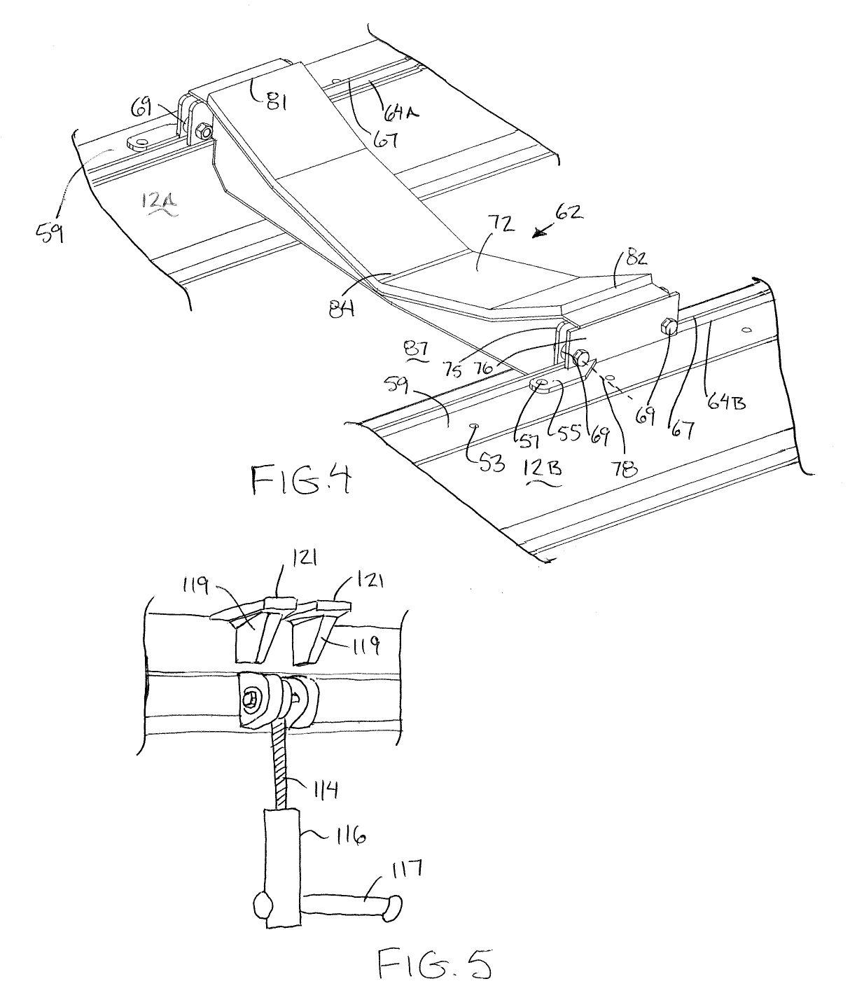

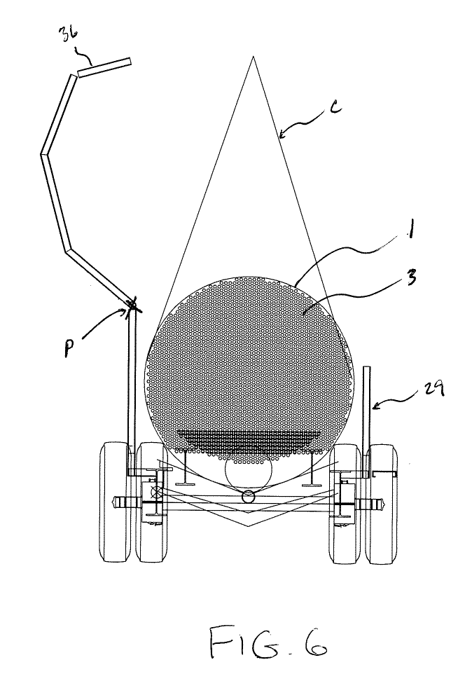

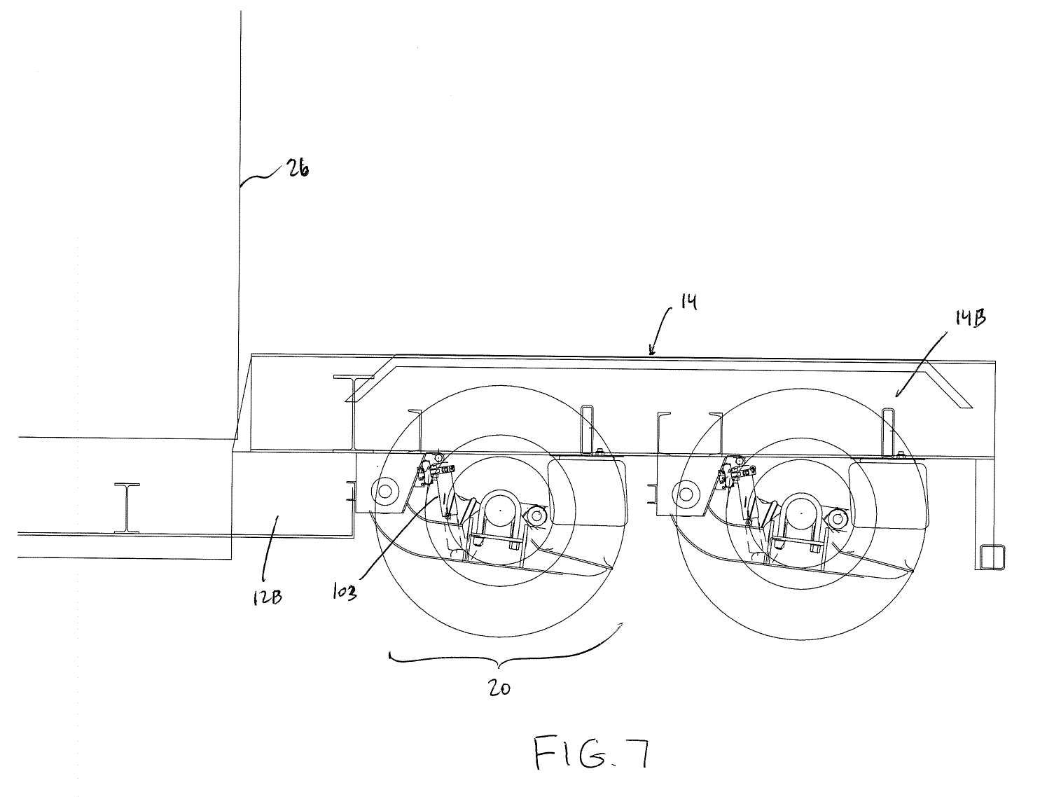

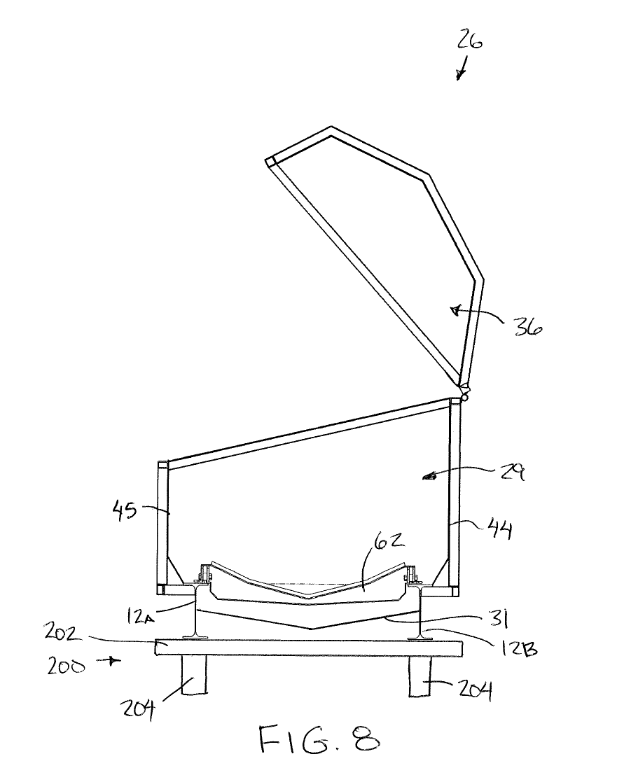

Referring to FIG. 3, in the illustrated arrangement a top inner one 57 of four side flanges oriented transversely to the upright web 47 of the respective longitudinal I-beam 12A, 12B protrudes into the containment structure such that the center frame's longitudinal beams 12A-B protrude partway into the containment structure so as to be exposed within the hollow interior thereof. On these interior-exposed portions of the longitudinal beams are defined horizontally-oriented upwardly-facing load bearing surfaces 59 within the containment structure that act to carry a weight of the elongated body when received in the containment structure. Thus the load bearing surfaces are supported on the overall frame in the transport trailer of the illustrated arrangement.

Supported on the load bearing surfaces 59 inside the containment structure 26 are a plurality of load supporting members 62, sometimes referred to in industry as load bunks, which directly carry the elongated body thereon and transfer the load thereof to the load bearing surfaces. The load supporting members 62, which may also be referred to herein as bunks for convenient reference, are elongated in a lateral direction of the center frame spanning between the longitudinal beams 12A-B so as to bridge a horizontal distance therebetween. The bunks 62 are disposed at longitudinally spaced locations in use when carrying the elongated body but may be varied in their longitudinal location with respect to the frame by displacement along a track inside the containment structure. In the illustrated arrangement all of the bunks are adjustable in their longitudinal location within the containment structure, but in other arrangements which are not shown only at least one bunk is so.

The track is formed by each one of a pair of upstanding flanges 64A-B, one on top of either one of the longitudinal beams 12A-B. Each flange extends upwardly from the respective load bearing surface 59 on a top of the respective beam 12A or 12B to a free top of the respective flange which defines a substantially horizontal rolling surface 67 for rollably supporting the position-adjustable bunks thereon. The flanges are elongated in a longitudinal direction of the center frame 12 so that the track extends in the longitudinal direction for adjusting the position of the respective bunk longitudinally of the containment structure.

Each bunk 62 comprises rollers 69, at least one of which is rotatably supported to either side laterally of an upper supporting surface 72 adapted for engaging the elongated body so that there is at least one roller on either side of the respective bunk 62 for rolling engagement with the rolling surface 67 of the respective track on either side of a central longitudinal axis of the containment structure. The rollers 69 are rotatably supported between a pair of downwardly extending parallel surfaces 75, 76 of a roller housing so that their roller axes 78 are oriented laterally of the central frame for rolling movement in the longitudinal direction thereof. These surfaces 75, 76 extend downwardly beyond bottoms of the rollers 69 to a location below the rolling surface 67 of the respective track which the roller(s) engages so that the surfaces 75, 76 one on either side of the track act as guide surfaces for maintaining the roller(s) on the respective track during rolling movement.

The upper supporting surface 72 of the respective bunk is sloped from either side 81, 82 thereof downwardly and towards the central longitudinal axis of the center frame to a central location 84 of the upper supporting surface which therefore is lower than opposite sides of the bunk 62 so as to form a cradle. Thus, the terminal sides of the upper supporting surface 72 are located above the load bearing surfaces 59 of the longitudinal beams 12A-B while the central location 84 is below same. Bottoms of the bunks 62 are spaced from the bottom pan 31, and since the bunks 62 are carried on the tops of the longitudinal beams 12A-B they are each carried at a spaced position above the bottom of the containment structure.

A row of fastener apertures 53 are provided at longitudinally spaced apart positions in the top side of each beam 12A and 12B within the load bearing surfaces 59 thereof. A locking bracket 55 is provided at each end of each bunk having a lock aperture 57 therein which is aligned with a respective one of the fasteners apertures 53 in each one of a plurality of different longitudinally spaced apart positions along the track. A locking fastener can be threadably secured through the lock aperture 57 and into a respective one of the fastener apertures to selectively fix the bunk at a selected one of the different longitudinally spaced apart positions along the track.

A plurality of rigid anchoring loops 86 (schematically shown) mounted inside the containment structure, such as to a top outer flange of the respective longitudinal beam or to the respective side wall 44, 45, at longitudinally spaced locations and on either side of the central longitudinal axis of the center frame define anchoring locations on an inside of the containment structure for receiving straps to secure the elongated body inside the containment structure. That is, after the elongated body is placed within the containment structure, it is secured in fixed relation against the load bearing surfaces 59 within the containment structure, via the bunks 62, by a member forming a band which extends from one side of the body to the other so as to maintain the elongated body in a secured, fixed position during transport.

As mentioned previously, elongated bodies which can be transported using the trailer 10 may carry a noxious substance thereon which is to be contained within the containment structure to prevent same from leaching into the ground. An upper collection surface 87 of the bottom pan 31 located within the hollow interior or, in other words, inside the containment structure is sloped from either side of the pan at the respective longitudinal beam 12A, 12B downwardly towards a lowered central location on the upper surface of the pan thereby defining a trough which extends longitudinally of the center frame. Thus any substance which falls on the upper collection surface of the pan is guided towards a common collection location on the pan which is a central, longitudinally extending portion of the bottom of the containment structure.

The transport trailer 10 includes a drain 90 in the bottom of the containment structure for removing from the containment structure the noxious substance which has collected on the pan 31, which is more clearly shown in FIG. 3. The drain 90 includes a spout 92 communicated with the bottom of the receptacle portion 29 with an aperture 93 formed at a bottom of the front wall 39 so that a bottom edge portion of the aperture 93 is located at the lowered central location of the upper collection surface 87, such that the drain is communicated with the interior of the containment structure. An open discharge end 95 at a lower end of the spout opposite to a drain inlet formed by the aperture 93 is closed by a removable cap 97. The discharge end 95 is adapted for connection to a vacuum truck which draws the noxious substance into its respective collection tank. A drain valve 99 (schematically shown) in a hollow interior passageway of the spout, so as to be inside the spout, and located intermediate the inlet and discharge openings of the drain is provided for selectively communicating the drain with the receptacle portion 29. For example, the drain valve 99 can be disposed in an open position in which the discharge opening of the drain is communicated with the interior of the containment structure or in a closed position in which the drain passageway is isolated from the containment structure interior. A lever (not shown) exterior to the spout and to the containment structure is operatively coupled to the drain valve 99 for selecting the desired position of the valve. The spout 92 is inclined and extends from the inlet aperture 93 located laterally centrally of the pan, so as to coincide with the lowered central location thereof, downwardly and laterally outwardly towards a side of the containment structure on which the shorter side wall 45 is located. The discharge end 95 is thus presented at a side of the center frame, protruding beyond an exterior side of the longitudinal beam 12B of the center frame.

In the illustrated arrangement the drain 90 is located at the front of the containment structure so as to be located at one end thereof. Thus the receptacle portion 29 of the containment structure can be disposed in an inclined position, with an opposite end of the receptacle portion distal to the drain 90 being raised relative to that end nearer which the drain is located, causing the noxious substance to flow by gravity towards the drain. In other arrangements the drain may not be located at the front end but simply may be closer to the front end than to the rear end of the containment structure, in which arrangement the spout depends from the pan 31 and the inlet aperture 93 is formed in the upper collection surface 87 at the central lower location thereof.

In order to dispose the containment structure in the inclined position for removal of the noxious substance via the drain, the wheel and axle assemblies 20 comprise suspension with conventional gas bags 103 which are operable for lifting the rear frame, and thus the rear of the overall frame, to orient the containment structure with its rear at a higher elevation than its front. In the illustrated arrangement the pan 31 of the containment structure forms a substantially horizontal trough and the length of the containment structure is far too long, for a shaping of the pan alone to be sufficient to direct the noxious substance collected thereon towards the drain. Thus, the gas bags are provided and can be operated to raise the rear of the containment structure to a prescribed height so that gravity can act to carry the noxious substance to the drain.

A spraying arrangement (not shown) can be mounted on an inside of the containment structure, particularly when the lid is in the closed position. The spraying arrangement may be a conventional arrangement including a supply conduit with a plurality of nozzles at longitudinally spaced locations to provide a sufficient coverage area of the interior of the containment structure. A coupler which is exposed at an exterior of the lid can be operatively communicated with the supply conduit so that a hose can be connected to the spraying arrangement via the coupler to deliver the cleansing fluid into the enclosed interior from an external source. Typically the cleansing fluid would collect on the pan and be removed via the drain.

The transport trailer also includes an operator support member 107 located externally of the containment structure extending in the longitudinal direction of the center frame along the shorter side wall 45. The operator support member 107 is mounted on a plurality of support plates 108 connected to the longitudinal beam 12B at longitudinally spaced locations therealong and extending laterally outwardly therefrom. The support member 107 is elongated in the longitudinal direction spanning the full length of the containment structure and has a width from the side of the containment structure to a distal edge 109 spaced laterally therefrom suitable for receiving a foot of an operator thereon as the member 107 defines at its top a substantially horizontal upper support surface 111 projecting transversely from the upstanding side wall 45 for supporting an operator. The operator support member 107 is disposed at an intermediate location between the bottom 31 of the containment structure and the upper perimeter edge 33 so that the operator can stand on the support member 107 and see inside the containment structure.

The transport trailer further includes a lock mechanism to secure the lid 36 in the closed position. In the illustrated arrangement, the lock mechanism comprises a first locking member formed by a pivotally connected threaded shaft 114 mounted on the shorter side wall 45 which threadably carries an enlarged head 116 with a handle 117 adapted for rotating the head 116 to displace same along the shaft 114 in an axial direction thereof. The shaft 114 with the head 116 can be pivoted about a longitudinally oriented axis located along the peripheral wall of the containment structure so as to be positioned in an upstanding position relative to this axis for cooperation with a second locking member carried on the lid. The second locking member is formed by a pair of abutment elements 119 located one to either side of the shaft 114 so that the shaft can be pivoted into a position therebetween. With the first locking member in the upstanding position, the enlarged head 116 is displaced along the shaft 114 downwardly towards the abutment elements which define substantially horizontal upper abutment surfaces 121 until the head 116 which is enlarged relative to the shaft in a radial direction thereof is brought into abutment with the surfaces 121. In this manner the first and second locking members cooperate to secure the lid in the closed position.

In use, with the lid 36 in the open position the elongated body 1 is lowered through the unobstructed access opening 34 into the receptacle portion 29 of the containment structure 26 typically via a crane C (schematically shown) or the like, and it is rested upon the bunks 62 which are already positioned at suitable longitudinal locations along the center frame according to the length of the elongated body. That is, prior to lowering of the elongated body into the receptacle portion, at least one of the position-adjustable bunks have been displaced along the track to a desired location therealong. With the elongated body received on the bunks, straps then can be wrapped about the body 1 from one side to the other and attached to the anchoring loops inside the containment structure to hold the body against the bunks in fixed location within the receptacle portion 29. The operator can transverse the operator support member 107 spanning the length of the containment structure to connect the straps to the anchoring locations, and to inspect the body 1. The lid may then be closed, and the lock mechanism, which is disposed at the same side of the containment structure where the operator support member is provided, is used to secure the lid in the closed position for transport.

Any noxious substance on the elongated body that may fall off same such as during transfer of the body 1 into the receptacle portion or during transport can be removed via the drain 90 when the transport trailer has been parked and disconnected from the tow vehicle. The gas bags 103 of the suspension at the rear frame 14 are operated to raise the rear end of the transport trailer to conduce collected substance to flow towards the drain 90 at the front of the containment structure.

After completed transport of the elongated body and when the body has been removed from the receptacle portion, the inside of the containment structure can be cleaned by rinsing with suitable cleansing fluid that is also drainable via the drain 90.

Turning now to FIG. 8, according to a further embodiment, the container 26 may include the beams 12A and 12B incorporated therein such that the container 26 can be deposited upon the flat deck 202 of an auxiliary trailer 200 having a respective structural frame. The structural frame of the trailer in this instance again comprises two elongate beams 204 extending in the longitudinal direction of the trailer between a hitch pin at the front end and a plurality of wheel assemblies at the rear end similar to the trailer noted above. The trailer 200 can thus be connected to a towing vehicle in the usual manner. the deck 202 is supported on the beams 204 which in turn support the beams 12A and 12B of the container 26 engaged thereon in transport. The container can thus be readily removed for use of the trailer in the usual manner of a flat deck trailer. In this instance, the bottom pan 31 remains connected between the beams 12A and 12B, however, the pan is raised in elevation so that the bottom apex remains above the bottom of the beams 12A and 12B in elevation.

The scope of the claims should not be limited by the preferred embodiments set forth in the examples but should be given the broadest interpretation consistent with the specification as a whole.

1. A transport trailer for transporting an elongated body carrying a noxious substance thereon, the transport trailer comprising:
a frame having a forward end and a rear end;
a hitch coupling supported at the forward end of the frame for connecting to a tow vehicle;
a plurality of wheel and axle assemblies rotatably supported at the rear end of the frame;
a containment structure supported on the frame so as to define a hollow interior suitable to receive the elongated body therein, the containment structure including a receptacle portion defining a receptacle for containing the noxious substance, an access opening at a top side of the receptacle portion for accessing the interior of the containment structure, and a closable lid carried on the receptacle portion and movable relative to the access opening between an open position in which the access opening is unobstructed and a closed position in which the access opening is covered so as to close the containment structure;
the interior of the containment structure being unobstructed from a front to a rear thereof in a manner so as not to obstruct placement of the elongated body therein;
load bearing surfaces within the containment structure which are supported on the frame;
and anchoring locations on an inside of the containment structure for receiving straps to secure the elongated body inside the containment structure in fixed relation against the load bearing surfaces within the containment structure.

2. The transport trailer according to claim 1 wherein there are provided a plurality of load supporting members at longitudinally spaced locations inside the containment structure supported on the load bearing surfaces for carrying the elongated body thereon, and at least one of the load supporting members is displaceable along a track inside the containment structure extending in a longitudinal direction of the frame for adjusting a position of said at least one of the load supporting members longitudinally of the containment structure.

3. The transport trailer according to claim 2 wherein said at least one of the load supporting members comprises rollers rotatably supported on either side thereof that rollably engage a respective track on either side of a central longitudinal axis of the containment structure.

4. The transport trailer according to claim 3 wherein the frame comprises a pair of longitudinally extending beams and the respective track is formed on each one of the pair of longitudinally extending beams.

5. The transport trailer according to claim 4 wherein the longitudinally extending beams of the frame protrude partway into the containment structure such that the load supporting members each are carried at a spaced position above a bottom of the containment structure.

6. The transport trailer according to claim 2 wherein each load supporting member includes an upper supporting surface having a central location which is lower than opposite sides of the respective load supporting member so as to form a cradle.

7. The transport trailer according to claim 1 wherein a bottom interior surface of the containment structure is sloped downwardly from either side of the containment structure so as to define a trough extending longitudinally of the frame.

8. The transport trailer according to claim 1 wherein there is provided a drain in a bottom of the containment structure that is communicated with the interior of the containment structure so that the noxious substance collected by the receptacle portion of the containment structure can be removed.

9. The transport trailer according to claim 8 wherein the drain is located closer to the front of the containment structure than to the rear thereof and the wheel and axle assemblies comprise gas bags operable for lifting the rear of the frame so as to dispose the containment structure in an inclined position so that the noxious substance flows by gravity towards the front of the containment structure for removal via the drain.

10. The transport trailer according to claim 8 wherein the drain is located at the front of the containment structure.

11. The transport trailer according to claim 1 wherein the frame comprises:
a center frame having forward and rear ends;
a forward frame at the forward end of the center frame supporting the hitch coupling;
a rear frame at the rear end of the center frame supporting the wheel and axle assemblies;
each of the center frame, the forward frame, and the rear frame including at least one longitudinally extending beam;
wherein the containment structure is on the center frame and a lower boundary of the containment structure is below the at least one beam of the rear frame and of the forward frame.

12. The transport trailer according to claim 1 further including an operator support member located externally of the containment structure and defining a substantially horizontal upper surface projecting transversely from an upstanding wall of the containment structure, the upper surface extending longitudinally of the frame for supporting an operator along a length of the containment structure.

13. The transport trailer according to claim 1 wherein the receptacle portion includes a bottom and a peripheral wall extending upwardly from bottom to an upper perimeter edge which delimits the access opening, the lid is pivoted about a pivot axis along one side of the peripheral wall and a portion of the upper perimeter edge opposite the pivot axis is located at a lower height than a portion of the upper perimeter edge along which the pivot axis extends.

14. The transport trailer according to claim 1 wherein the access opening spans a full length of the containment structure.

15. The transport trailer according to claim 1 further including a first locking member carried on a peripheral wall of the containment structure that is cooperative with a second locking member carried on the lid to secure the lid in the closed position.

16. The transport trailer according to claim 1 in combination with the elongated body which is a heat exchanger in the form of a package of tubes used in oil and gas industry.

17. A containment structure for transporting an elongated body carrying a noxious substance using a transport trailer in which the transport trailer includes a trailer structure having a forward end and a rear end, a hitch coupling supported at the forward end of the trailer structure for connecting to a tow vehicle, a plurality of wheel and axle assemblies rotatably supported at the rear end of the trailer structure, the containment structure comprising:
a frame for being received on the trailer structure of the transport trailer;
a containment structure supported on the frame so as to define a hollow interior suitable to receive the elongated body therein, the containment structure including a receptacle portion defining a receptacle for containing the noxious substance, an access opening at a top side of the receptacle portion for accessing the interior of the containment structure, and a closable lid carried on the receptacle portion and movable relative to the access opening between an open position in which the access opening is unobstructed and a closed position in which the access opening is covered so as to close the containment structure;
the interior of the containment structure being unobstructed from a front to a rear thereof in a manner so as not to obstruct placement of the elongated body therein;
load bearing surfaces within the containment structure which are supported on the frame;
and anchoring locations on an inside of the containment structure for receiving straps to secure the elongated body inside the containment structure in fixed relation against the load bearing surfaces within the containment structure.
